(19) United States
(12) Patent Application Publication
(10) Pub. No.: US 2014/0294193 A1
(43) Pub. Date: Oct. 2, 2014

(54) TRANSDUCER APPARATUS WITH IN-EAR MICROPHONE

(71) Applicants: Miikka Tikander, Helsinki (FI); Jouni Knuuttila, Espoo (FI); Ville Riikonen, Helsinki (FI); Antti Pekka Kelloniemi, Helsinki (FI)

(72) Inventors: Miikka Tikander, Helsinki (FI); Jouni Knuuttila, Espoo (FI); Ville Riikonen, Helsinki (FI); Antti Pekka Kelloniemi, Helsinki (FI)

(73) Assignee: NOKIA CORPORATION, Espoo (FI)

(21) Appl. No.: 13/983,874

(22) PCT Filed: Feb. 25, 2011
(86) PCT No.: PCT/IB11/50812

§ 371 Date: Sep. 24, 2013

(51) Int. Cl. H04R 1/08; H04R 1/10

(52) U.S. Cl. CPC H04R 1/08; H04R 1/1016
USPC 381/74

(57) ABSTRACT

Apparatus comprising: a first earpiece comprising a first microphone transducer; a second earpiece comprising a first speaker transducer; and a coupling between the first microphone transducer in the first earpiece to the first speaker transducer in the second earpiece configured to enable an audio signal dependent on the first microphone transducer output to be output by the first speaker transducer.

### FIELD OF THE APPLICATION

The present invention relates to a transducer apparatus. The invention further relates to, but is not limited to, a transducer apparatus for use in mobile devices.

### BACKGROUND OF THE APPLICATION

Many portable devices, for example mobile telephones, contain a number of acoustic transducers, such as microphones, earpieces and speakers.

In known acoustic transducer configurations, the mechanical design of the sound channels is fixed at the point of hardware design and manufacture of the device is completed, and cannot be later adapted during use for a specific purpose or desired configuration. Instead, any desired acoustic properties are achieved by filtering the electrical signal representing the sound output before the signal is applied to the transducer. Typically, this requires the use of significant processing power, commonly provided by dedicated digital signal processors (DSPs).

One such mechanical design limitation occurs during the use of headphone or headset transducers and particularly closed or in ear designs where the headphone transducer can ‘boost’ the user's own voice due to a closure of the ear canal. This ‘boost’ occurs whenever the user speaks as the portion of their own voice ‘heard’ by conduction of the voice through the jaw and skull bones is significantly higher than the portion of the voice heard by air conduction when compared to the portions ‘heard’ when the ear canal is open. This ‘boost’ makes the users own voice sound very boomy in their ears. This can lead to the user of the device pausing unnaturally during speech when ‘hearing’ their own voice.

To attempt to improve the user's experience some headsets or headphones can have mounted a microphone outside of the earpiece. This microphone signal detecting the air conducted voice signal can route the air conducted voice signal to the earphone transducer producing a more natural voice audio experienced by the user. This signal routing from the microphone to the speaker can be called the side tone.

External microphones however have an additional problem in that as well as receiving the air conducted voice audio signal the microphone will detect background noise which when fed back into the earpiece transducer causes the audio signal to be difficult to understand.

A further improvement to the external microphone with respect to reducing noise is to use an in-ear microphone transducer to detect the voice audio signal and pass this back to the user via the earpiece transducer to simulate the air conducted voice audio.

There can however be also problems where using an in-ear headset as although external noise is reduced where the headset has a microphone in the ear canal the routing of the in-ear microphone signal to the ear-piece transducer can create a delay free acoustic feedback loop. This can produce a typical feedback speaker howl as the system generates positive feedback.

### STATEMENT OF THE APPLICATION

This application proceeds from the consideration that in-ear microphone feedback can be avoided where the side tone signal is fed from one earpiece to the speaker of the other earpiece.

It is an aim of at least some embodiments of the invention to address one or more of these problems.

According to a first aspect there is provided an apparatus comprising: a first earpiece comprising a first microphone transducer; a second earpiece comprising a first speaker transducer; and a coupling between the first microphone transducer in the first earpiece to the first speaker transducer in the second earpiece configured to enable an audio signal dependent on the first microphone transducer output to be output by the first speaker transducer.

Each of the first and second earpiece may comprise in-ear earpieces.

The first microphone may be at least one of: an in ear-microphone; a contact microphone; and a skin contact microphone.

The coupling may comprise a signal processing unit configured to generate a processed signal dependent on the first microphone transducer output and output the processed signal to the first transducer second earpiece.

The signal processing unit may comprise at least one of: an analogue filter; an analogue mixer configured to mix the microphone transducer output with a further signal; and an analogue delay configured to delay the microphone transducer output.

The signal processing unit may comprise: an analogue to digital converter configured to receive the first microphone transducer output and generate a digital microphone signal; a digital signal processor configured to digitally process the digital microphone signal and generate a digitally processed microphone signal; and a digital to analogue converter configured to receive the digitally processed microphone signal and generate the processed signal.

The digital signal processor may be configured to perform at least one of: filtering the digital microphone signal; mixing the digital microphone signal with a further signal; and delaying the digital microphone signal.

The further signal may comprise at least one of: a received telecommunication signal; and an audio signal.

The coupling between the first microphone transducer in the first earpiece to the first speaker transducer in the second earpiece may comprise at least one of: a wired coupling; and a wireless coupling.

The coupling between the first microphone transducer in the first earpiece to the first speaker transducer in the second earpiece may comprise: a direct coupling; and an indirect coupling.

The second earpiece may comprise a second microphone transducer and the first earpiece comprises a second speaker transducer, and the coupling may be further configured to couple between the second earpiece microphone transducer to the first earpiece speaker transducer and be configured to enable an audio signal dependent on the second earpiece microphone transducer output to be output by the first earpiece speaker transducer.

The apparatus may further comprise a selector configured to select one of an audio signal dependent on the second microphone transducer output and an audio signal dependent on the microphone transducer output.

According to a second aspect there is provided a method comprising: capturing a first audio signal at a first earpiece first microphone transducer; coupling the first earpiece first microphone transducer with a second earpiece first speaker transducer; and outputting by the second earpiece first speaker transducer a second audio signal dependent on the first audio signal.

Each of the first and second earpiece may comprise in-ear earpieces.

The first microphone may be at least one of: an in ear-microphone; a contact microphone; and a skin contact microphone.

Coupling the first earpiece first microphone transducer with a second earpiece first speaker transducer may comprise signal processing the first audio signal to generate a processed first audio signal to the second earpiece first transducer.

Signal processing may comprise at least one of: analogue filtering the first audio signal; analogue mixing the first audio signal with a further signal; and analogue delaying the first audio signal.

Signal processing may comprise: analogue to digital converting the first audio signal to generate a digital representation of the first audio signal; digital signal processing the digital representation of the first audio signal and generate a digital representation of the second audio signal; and digital to analogue converting the digital representation of the second audio signal to generate the second audio signal.

Digital signal processing may comprise at least one of: filtering the digital representation of the first audio signal; mixing the digital representation of the first audio signal with a further signal; and delaying the digital representation of the first audio signal.

The further signal may comprise at least one of: a received telecommunication signal; and a further audio signal.

Coupling the first earpiece first microphone transducer with a second earpiece first speaker transducer may comprise at least one of: wired coupling; and wireless coupling.

Coupling the first earpiece first microphone transducer with a second earpiece first speaker transducer may comprise at least one of: a direct coupling; and an indirect coupling.

The method may further comprise capturing a third audio signal at a first earpiece first microphone transducer; and selecting the first audio signal to be coupled over selecting the third audio signal dependent on the first and third audio signal characteristics.

According to third aspect there may be provided apparatus comprising: means for capturing a first audio signal at a first earpiece first microphone transducer; means for coupling the first earpiece first microphone transducer with a second earpiece first speaker transducer; and means for outputting at the second earpiece first speaker transducer a second audio signal dependent on the first audio signal.

Each of the first and second earpiece may comprise in-ear earpieces.

The first microphone may be at least one of: an in ear-microphone; a contact microphone; and a skin contact microphone.

The means for coupling the first earpiece first microphone transducer with a second earpiece first speaker transducer may comprise means for signal processing the first audio signal to generate a processed first audio signal to the second earpiece first transducer.

The means for signal processing may comprise at least one of: means for analogue filtering the first audio signal; means for analogue mixing the first audio signal with a further signal; and means for analogue delaying the first audio signal.

The means for signal processing may comprise: means for analogue to digital converting the first audio signal to generate a digital representation of the first audio signal; means for digital signal processing the digital representation of the first audio signal and generate a digital representation of the second audio signal; and means for digital to analogue converting the digital representation of the second audio signal to generate the second audio signal.

The means for digital signal processing may comprise at least one of: means for filtering the digital representation of the first audio signal; means for mixing the digital representation of the first audio signal with a further signal; and means for delaying the digital representation of the first audio signal.

The further signal may comprise at least one of: a received telecommunication signal; and a further audio signal.

The means for coupling the first earpiece first microphone transducer with a second earpiece first speaker transducer may comprise at least one of: means for wired coupling; and means for wireless coupling.

The means for coupling the first earpiece first microphone transducer with a second earpiece first speaker transducer may comprise at least one of: means for direct coupling; and means for indirect coupling.

The apparatus may further comprise means for capturing a third audio signal at a first earpiece first microphone transducer; and means for selecting the first audio signal to be coupled over selecting the third audio signal dependent on the first and third audio signal characteristics.

### SUMMARY OF FIGURES

For better understanding of the present invention, reference will now be made by way of example to the accompanying drawings in which:

FIG. 1 shows schematically an apparatus employing embodiments of the application;

FIG. 2 shows schematically the apparatus in further detail;

FIG. 3 shows a flow diagram showing the operation of the apparatus; and

FIG. 4 shows schematically a further arrangement of apparatus employing embodiments of the application.

### DESCRIPTION OF EXAMPLE EMBODIMENTS

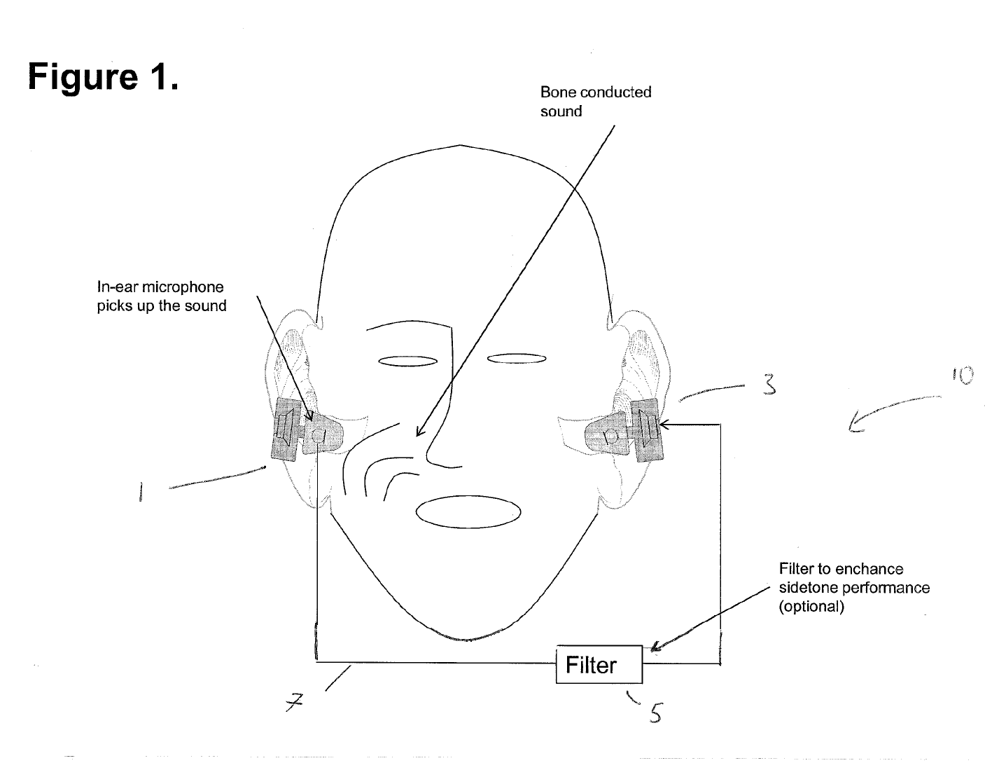

The following describes in further detail suitable apparatus and possible mechanisms for the provision improved performance of closed ear canal headphones and headsets. In this regard reference is first made to FIG. 1 which shows a schematic diagram of apparatus 10, which may be employed in some embodiments.

The apparatus 10 can in some embodiments comprise a stereo headset or stereo headphone configuration of transducers. The stereo headset (or in some embodiments headphones) are shown comprising a first (or left relative to the user) earpiece 3, a second (or right relative to the user) earpiece 1, and an electrical coupling 7 between the two earpieces. In the following example each earpiece is an in-ear earpiece, in other words suitable for being inserted at least partially in the ear canal however it would be appreciated that in some other embodiments the earpiece could be any suitable ‘closed’ arrangement where the ear canal is isolated or substantially isolated from the audio environment surrounding the earpiece.

Each of the earpieces 1,3 can in some embodiments comprise a microphone or microphone transducer configured to receive (or detect) voice audio or acoustic waves transmitted via the ear canal, and/or jawbone, and/or skull and furthermore in some embodiments an earpiece or speaker transducer configured to generate acoustic waves to be transmitted via the ear canal to the user.

The apparatus 10 in some embodiments can optionally comprise a filter 5. The filter 5 is configured in some embodiments to receive audio signals and process these according to a defined frequency response distribution. The filter 5 can in some embodiments be implemented to process analogue audio signals. In some other embodiments the filter 5 can be configured to process digital signals. In some embodiments the filter 5 can be configured to receive signals from one of the earpiece microphone transducers, process this audio signal and output a processed audio signal to the other earpiece speaker transducer.

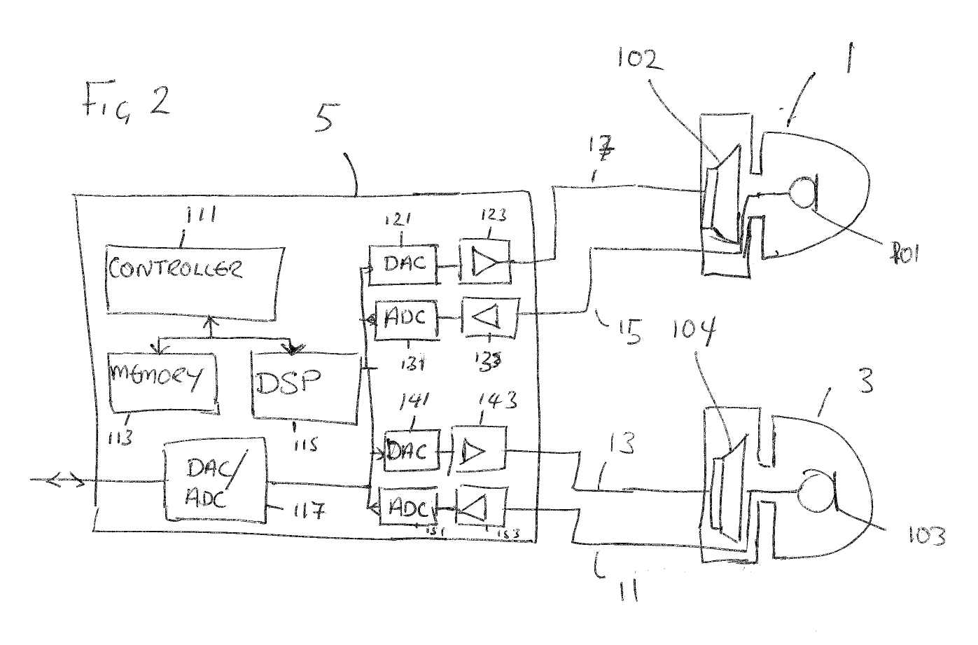

With respect to FIG. 2 the apparatus 10 is shown in further detail.

The first earpiece 3 in some embodiments comprises the microphone transducer 103 configured to receive (or detect) voice audio or acoustic waves transmitted via the left ear canal, and/or jawbone, and/or skull and pass the generated analogue signal to the filter 5 via a first microphone coupling 11. The microphone transducer 103 can be implemented using any suitable microphone technology. For example in some embodiments the microphone transducer comprises a micro-electro-mechanical system (MEMS) microphone. Furthermore in some embodiments the first earpiece comprises the speaker transducer 104 configured to generate acoustic waves to be transmitted via the ‘left’ ear canal to the user. The speaker transducer 104 can also be any suitable speaker or transducer technology capable of being located within the ear piece 3 and providing a suitable output frequency range and volume. The first earpiece 3 speaker transducer 104 can in some embodiments be configured to receive an analogue signal to be output by the transducer via a first speaker coupling 13.

The second earpiece 1 in some embodiments can comprise the microphone transducer 101 configured to receive (or detect) voice audio or acoustic waves transmitted via the right ear canal, and/or jawbone, and/or skull and pass the generated analogue signal to the filter 5 via a second microphone coupling 15. The microphone transducer 101 can be implemented in a manner similar to the microphone transducer of the first earpiece using any suitable microphone technology. For example in some embodiments the microphone transducer comprises a micro-electro-mechanical system (MEMS) microphone. Furthermore in some embodiments the second earpiece 1 comprises the speaker transducer 102 configured to generate acoustic waves to be transmitted via the ‘right’ ear canal to the user. The speaker transducer 102 can also be any suitable speaker or transducer technology capable of being located within the ear piece 1 and providing a suitable output frequency range and volume. The first earpiece 1 speaker transducer 102 can in some embodiments be configured to receive an analogue signal to be output by the transducer via a second speaker coupling 17.

The apparatus described herein shows an example which permits bi-directional side tone generation, in other words that a side tone signal can be passed from either ear to the opposite ear. It would further be understood that in some embodiments the apparatus 10 can be configured to provide uni-directional side tone generation in that one or either of the earpieces is implemented comprising only a speaker transducer. For example in some embodiments the first earpiece could comprise the microphone transducer and the second earpiece could comprise the speaker transducer only for left to right side tone generation. Similarly a right to left uni-directional side tone generator apparatus could comprise a first earpiece comprising the speaker transducer only and the second earpiece comprising the microphone transducer.

In some embodiments the first and second earpieces are not ‘handed’ in other words can be inserted into either ear. Thus the first earpiece could be either the left or the right earpiece and similarly the second earpiece could be the opposite earpiece to the first earpiece.

The filter 5, which as described herein is an optional component of the apparatus 10, can in some embodiments receive the first earpiece 3 microphone 103 audio signal via the first microphone coupling 11. Furthermore in some embodiments the filter 5 can be configured to receive the second earpiece 1 microphone 101 audio signal via the second microphone coupling 15.

The filter 5 can in some embodiments be configured to receive an analogue signal from each microphone transducer. In such embodiments the filter 5 can comprise a first microphone amplifier 153 which receives the first microphone signal and outputs an amplified microphone signal to a first analogue-to-digital converter 151. Furthermore in some embodiments the filter 5 can comprise a similar second microphone amplifier 133 which is configured to receive the second microphone signal and outputs an amplified second microphone signal to a second analogue-to-digital converter 131. In some embodiments there can be a single multi-channel amplifier or preamplifier wherein each earpiece microphone signal is a separate input channel.

It would be understood that in some embodiments the first and second amplifiers can be implemented physically within the earpieces such that the first earpiece when comprising a microphone can further comprise an amplifier to amplify the microphone signal before outputting it, and similarly the second earpiece when comprising a microphone can further comprise an amplify the microphone signal of second earpiece before outputting the audio signal. The amplifier can be any suitable amplifier, for example a microphone pre-amplifier suitable for boosting the microphone audio signal to a suitable level for further processing.

In some embodiments the amplifier or pre-amplifier can be implemented within the microphone structure. For example in some embodiments the microphone transducer and amplifier can be implemented as an integrated microphone configured to output a suitably amplified signal. It would be understood that in some embodiments where there is only one microphone there can similarly be optionally one amplifier. Furthermore in some embodiments it would be understood that where the microphone output a signal at a suitable level for further processing then each amplifier is optional.

In some embodiments the filter 5 can comprise a first analogue-to-digital converter (ADC) 151. The first analogue-to-digital converter 151 can be any suitable analogue-to-digital converter suitable for generating a digital signal suitable for further processing, storage or output from the first microphone output. The filter 5 can further comprise a second analogue-to-digital converter (ADC) 131. The second analogue-to-digital converter 131 can similarly be any suitable analogue-to-digital converter suitable for generating a digital signal suitable for further processing, storage or output from the second microphone output. In some embodiments there can be a single multi-channel ADC wherein each earpiece microphone signal is a separate input channel.

In some embodiments the analogue-to-digital converter can be implemented within the earpiece or microphone structure. For example in some embodiments the microphone transducer and analogue-to-digital converter can be implemented as an integrated microphone configured to output a suitably converted signal. Furthermore in some embodiments the microphone transducer, amplifier and ADC can be implemented within a single device, such as an integrated microphone or MEMS microphone.

It would be understood that in some embodiments where there is only one microphone there can similarly be optionally one analogue-to-digital converter. Furthermore in some embodiments it would be understood that where each microphone outputs a signal in a digital format then the analogue-to-digital converter within the filter is optional.

In some embodiments the filter 5 can further comprise a digital signal processor (DSP) 115. The DSP 115 can in some embodiments process the signals received from the microphone transducers prior being output to the other earpiece and/or another device. For example in some embodiments the DSP 115 can be configured to perform filtering on the received microphone signals. The DSP 115 can in some embodiments be implemented as at least one program running on a processor.

In some embodiments the filter 5 can further comprise a controller 111. The controller 111 can be in some embodiments implemented as a processor and/or as programs configured to run on a processor and which can be stored in memory. The controller 111 can in some embodiments be configured to control the DSP 115 in such a way that the DSP 115 can modify the processing of the data dependent on the controller 111. Although not described in further detail in some embodiments the filter 5 can comprise an input, for example a user interface, for the user to control the processing of the microphone signals before being output to the other earpiece. For example in some embodiments the user interface can provide inputs to the controller 111 which in turn can change or modify parameters associated with the digital signal processor to control the filtering of an earpiece microphone signal prior to being input to the user.

In some embodiments the filter 5 can comprise a memory 113. The memory 113 can in some embodiments comprise a program storage section configured for storage of programs such as for example the control program run by the controller and the processing program or programs run by the digital signal processor. Furthermore the memory 113 can in some embodiments comprise a data storage section configured for storage of data such as the microphone audio signals and processed audio signals.

The filter 5 can in some embodiments further comprise a first digital-to-analogue converter (DAC) 141 configured to generate a suitable analogue signal from a digital signal, such as the processed digital microphone signal. In some embodiments the first DAC 141 can be configured to output the analogue signal to a first speaker amplifier 143. Furthermore in some embodiments the filter 5 can comprise a second digital-to-analogue converter (DAC) 121 configured to generate a suitable analogue signal from a digital signal, such as the processed digital microphone signal. In some embodiments the second DAC 121 can be configured to output the analogue signal to a second speaker amplifier 123. In some embodiments there can be a single multi-channel DAC wherein each digital signal for each earpiece is a separate input channel.

In some embodiments the digital-to-analogue converter can be implemented within the earpiece. For example in some embodiments the digital-to-analogue converter can be implemented as an integrated speaker transducer configured to receive a digital signal and output a suitable acoustic wave. Furthermore in some embodiments the speaker transducer, speaker amplifier and DAC can be implemented within a single device, such as an integrated transducer structure.

The filter 5 can further comprise a first speaker amplifier 143 configured to receive the analogue signal from the first DAC 141, and output an amplified signal suitable for powering a transducer speaker such as the first earpiece 3 speaker 104. In some embodiments the filter 5 can further comprise a second speaker amplifier 123 configured to receive the analogue signal from the second DAC 121, and output an amplified signal suitable for powering a transducer speaker such as the second earpiece 1 speaker 102. In some embodiments there can be a single multi-channel amplifier wherein each signal to be output to a different earpiece is a separate input channel.

It would be understood that in some embodiments the first and second speaker amplifiers can be implemented physically within the earpieces such that the first earpiece when comprising a speaker transducer can further comprise a speaker amplifier to amplify the signal before outputting it to the transducer, and similarly the second earpiece when comprising a speaker transducer can further comprise an amplifier to amplify the signal before outputting it to the second earpiece transducer. The speaker amplifiers can be any suitable amplifier.

In some embodiments the filter 5 can further comprise an additional interface digital-to-analogue converter/analogue-to-digital converter 117 suitable for passing signal data to and from a further external coupling. This external coupling can for example be configured to couple the filter to a mobile phone or other device such that audio data from the external device is passed to at least one of the earpieces. In such embodiments the DSP 115 can be configured to mix the audio signal received with from the external device with the microphone audio signal or processed microphone audio signal prior to outputting the combined audio signal to at least one of the earpieces.

In some embodiments the filter 5 or at least components of the filter 5 can be implemented physically within one of the earpieces, in both of the earpieces, or the components spread across both earpiece units.

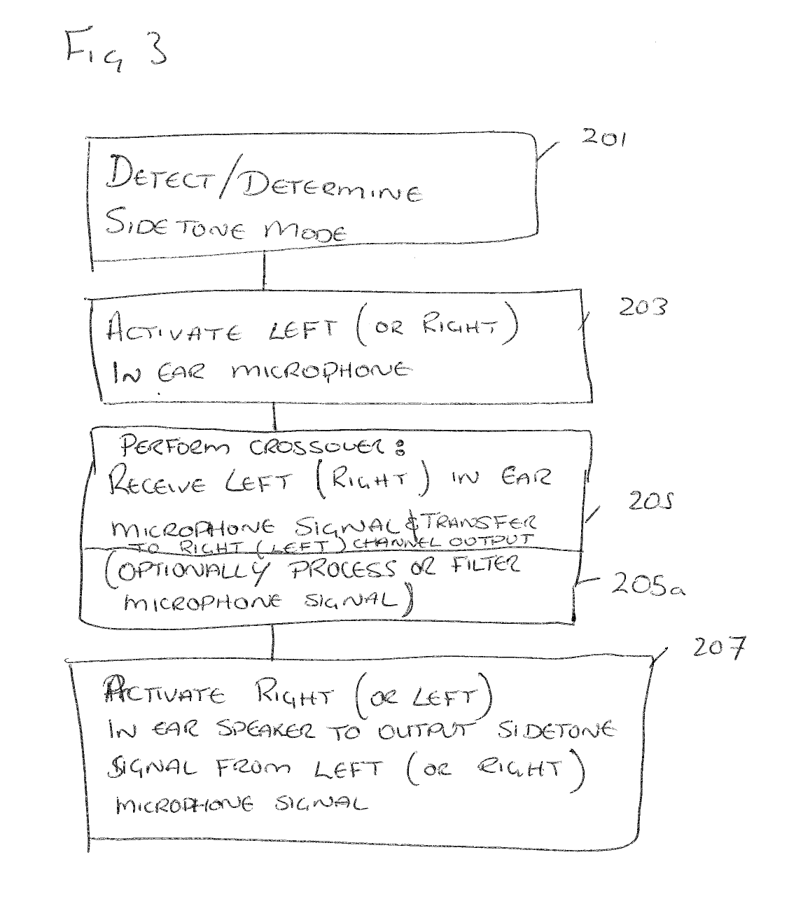

With respect to FIG. 3 the operation of the apparatus 10 according to some embodiments of the application is described in further detail.

In some embodiments the controller 111 can detect or determine whether the apparatus should produce a side tone. In some embodiments the controller 111 can be configured to monitor the input from the external coupling to detect an incoming signal or in some embodiments the controller 111 can be configured to receive an input from a user interface.

The detection or determining for the apparatus to generate a side tone is shown in FIG. 3 by step 201.

Furthermore the controller 111 can ‘activate’ at least one of the earpiece microphones. In some embodiments, for example where the microphone amplifier and analogue-to-digital converter are implemented within the earpiece this can involve switching on or activating the amplifier/ADC components of the microphone assembly.

In this example the left earpiece in-ear microphone is activated, in other words using the example apparatus shown in FIGS. 1 and 2 the signal from the first earpiece 3 microphone 103 is received via the coupling to the first microphone amplifier 153, and the first analogue-to-digital converter 151. It would be understood that in some other embodiments the right earpiece microphone can be activated or in other words the audio signal generated by the microphone switched to be output. In some embodiments both the left and the right earpiece microphones are ‘activated’.

The activation of the left (or in some embodiments right) in-ear microphone is shown in FIG. 3 by step 203.

In some embodiments the apparatus performs a crossover. The crossover is when the audio signal from one of the earpiece microphones is converted into a form suitable for output to the other of the earpieces. In some embodiments this can be performed by a simple switching arrangement whereby the microphone signal from one earpiece is coupled to the transducer of the other earpiece. In some other embodiments the switching arrangement can further comprise mixing with external audio signals.

In some embodiments the crossover is performed digitally by the digital signal processor receiving the digital microphone signals from one earpiece and adding these signal values to the other earpiece transducer output signal.

The crossover operation, which in this example is receiving the left (or in some embodiments right) in-ear microphone signal and generating a suitable right (or in corresponding embodiments left) earpiece transducer signals is shown in FIG. 3 by step 205.

Optionally, the microphone signal can be processed by the filter 5, for example by the DSP 115. In some embodiments this processing can be performed to attempt to improve the side tone performance. In some other embodiments the processing by the DSP 115 can be a mixing of the microphone signal with an external signal prior to outputting a combined audio signal.

In some further embodiments, for example where there the potential for bidirectional side tone generation exists where each earpiece has a microphone and speaker, the filter 5 could further determine whether one or other of the microphones is producing a better signal and select the output from this signal over the output from the other earpiece microphone. For example one or other of the earpieces may be better seated within the ear and therefore determining a better quality voice signal. For example the filter could compare the microphone signals from each earpiece and select the signal with the highest volume and which is not saturated.

The optional operation of signal processing or filtering the microphone signal is shown in FIG. 3 by step 205a.

Thus in other words using the example apparatus shown in FIG. 2, the analogue microphone signal received passes via the first microphone amplifier 153, the first microphone analogue-to-digital converter 151, optionally to the digital signal processor 115 and processed dependent on the controller, the second digital-to-analogue converter 121 and the second earpiece speaker amplifier 123 to be output to the second earpiece speaker 102.

Similarly the other side tone generation pathway can be defined as the second microphone signal received passes via the second microphone amplifier 133, the second microphone analogue-to-digital converter 131, optionally to the digital signal processor 115 and processed dependent on the controller, the first digital-to-analogue converter 141 and the first earpiece speaker amplifier 143 to be output to the first earpiece speaker 104.

It would be understood than in embodiments of the application that both pathways are not implemented at the same time, in other words although there is in some embodiments the possibility of implementing a left-right crossover side tone and a right-left crossover side tone only one is implemented at any time.

The activation of the right (or in some embodiments the left) in-ear speaker transducer to output side tone signal from the left (in respective embodiments right) microphone signal is shown in FIG. 3 by step 207.

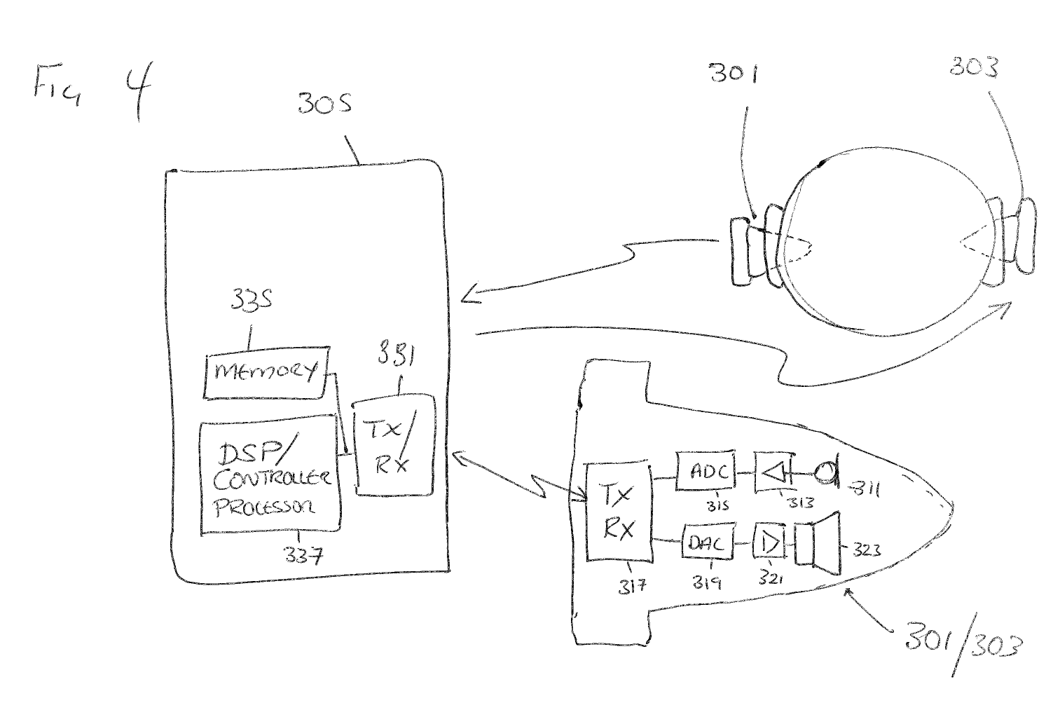

With respect to FIG. 4, further examples of apparatus suitable for implementing embodiments of the application are described. The apparatus in these embodiments comprises earpieces 301, 303 which are wirelessly coupled to a mobile apparatus or electronic device 305. The mobile device 305 can be any suitable mobile device. The electronic device 305 can for example be a mobile terminal, user equipment of a wireless communication system, portable audio player (also known as an mp3 player), portable media player (also known as an mp4 player), or a portable games console.

In such embodiments each earpiece comprises a microphone 311, and microphone pathway for processing the microphone signal such as an internal microphone amplifier 313, and an internal analogue-to-digital converter 315. The earpiece further comprises a transceiver 317 or transmitter for transmitting the microphone signal to the mobile device 305. The microphone, analogue-to-digital converter and amplifier can in some embodiments be similar to those features described herein with respect to FIG. 2.

Furthermore the earpiece transceiver 317 can comprise a speaker pathway. The speaker pathway can in some embodiments comprise the transceiver 307 (or a separate receiver) configured to receive audio signals to be output by the earpiece, a digital-to-analogue converter 319, a speaker amplifier 321, and a speaker 323 for outputting a suitable speaker acoustic signal when the earpiece 301, 303 is placed in the ear.

In some embodiments the mobile device 305 can comprise a processor or a processor 337 chipset configured to perform the operations of digital signal processor and/or controller, a transceiver 331 configured to transmit and receive the audio signals to and from the earpieces and optionally also to receive and transmit signals with further electronic devices (for example for communication over a cellular network), and a memory 335 for storing programs and/or data.

The operation of such embodiments is similar to the operations described herein with respect to FIG. 3 with the additional operations of wirelessly communicating between the earpieces.

In some embodiments at least some of the operations of the mobile device 305 are implemented within at least one of the earpieces 301, 303. In such embodiments the earpieces can be configured to communicate directly between each other. For example in some embodiments the left earpiece could be configured to transmit the microphone audio signal directly with the right earpiece, wherein the right earpiece further comprises the cellular communication equipment and mixes the left earpiece microphone signal with incoming audio signals to generate a more natural sounding communication.

It would be understood that each earpiece in these embodiments would require its own power source such as a battery or other electrical power generation unit as the earpiece would not be able to source power from a wired coupling.

The processor 21 may be configured to execute various program codes. The implemented program codes may comprise encoding code routines. The implemented program codes 23 may further comprise an audio decoding code. The implemented program codes 23 may be stored for example in the memory 22 for retrieval by the processor 21 whenever needed. The memory 22 may further provide a section 24 for storing data.

Thus, a user equipment may comprise one or more of the transducers as described above.

It shall be appreciated that the term user equipment is intended to cover any suitable type of wireless user equipment, such as mobile telephones, portable data processing devices or portable web browsers. Furthermore, it will be understood that the term acoustic sound channels is intended to cover sound outlets, channels and cavities, and that such sound channels may be formed integrally with the transducer, or as part of the mechanical integration of the transducer with the device.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising:
a first earpiece comprising a first microphone transducer;
a second earpiece comprising a first speaker transducer; and
a coupling between the first microphone transducer in the first earpiece to the first speaker transducer in the second earpiece configured to enable an audio signal dependent on the first microphone transducer output to be output by the first speaker transducer.

2. The apparatus as claimed in claim 1, wherein each of the first and second earpiece comprise in-ear earpieces.

3. The apparatus as claimed in claim 1, wherein the first microphone is at least one of:
an in ear-microphone;
a contact microphone; and
a skin contact microphone.

4. The apparatus as claimed in claim 1, wherein the coupling comprises a signal processing unit configured to generate a processed signal dependent on the first microphone transducer output and output the processed signal to the first transducer second earpiece.

5. The apparatus as claimed in claim 4, wherein the signal processing unit comprises at least one of:
an analogue filter;
an analogue mixer configured to mix the microphone transducer output with a further signal; and
an analogue delay configured to delay the microphone transducer output.

6. The apparatus as claimed in claim 4, wherein the signal processing unit comprises:
an analogue to digital converter configured to receive the first microphone transducer output and generate a digital microphone signal;
a digital signal processor configured to digitally process the digital microphone signal and generate a digitally processed microphone signal; and
a digital to analogue converter configured to receive the digitally processed microphone signal and generate the processed signal.

7. The apparatus as claimed in claim 6, wherein the digital signal processor is configured to cause the apparatus to at least one of:
filter the digital microphone signal;
mix the digital microphone signal with a further signal; and
delay the digital microphone signal.

8. The apparatus as claimed in claim 7, wherein the further signal comprises at least one of:
a received telecommunication signal; and
an audio signal.

9. The apparatus as claimed in claim 1, wherein the coupling between the first microphone transducer in the first earpiece to the first speaker transducer in the second earpiece comprises at least one of:
a wired coupling; and
a wireless coupling.

10. The apparatus as claimed in claim 1, wherein the coupling between the first microphone transducer in the first earpiece to the first speaker transducer in the second earpiece comprises:
a direct coupling; or
an indirect coupling.

11. The apparatus as claimed in claim 1, wherein the second earpiece comprises a second microphone transducer and the first earpiece comprises a second speaker transducer, and the coupling is further configured to couple between the second earpiece microphone transducer to the first earpiece speaker transducer and be configured to enable an audio signal dependent on the second earpiece microphone transducer output to be output by the first earpiece speaker transducer.

12. The apparatus as claimed in claim 11, further comprising a selector configured to select one of an audio signal dependent on the second microphone transducer output and an audio signal dependent on the microphone transducer output.

13. A method comprising:
capturing a first audio signal at a first earpiece first microphone transducer;
coupling the first earpiece first microphone transducer with a second earpiece first speaker transducer; and
outputting by the second earpiece first speaker transducer a second audio signal dependent on the first audio signal.

14. The method as claimed in claim 13, wherein each of the first and second earpiece comprise in-ear earpieces.

15. The method as claimed in claim 13, wherein the first microphone is at least one of:
an in ear-microphone;
a contact microphone; and
a skin contact microphone.

16. The method as claimed in claim 13, wherein coupling the first earpiece first microphone transducer with a second earpiece first speaker transducer comprises signal processing the first audio signal to generate a processed first audio signal to the second earpiece first transducer.

17. The method as claimed in claim 16, signal processing comprises at least one of:
analogue filtering the first audio signal;
analogue mixing the first audio signal with a further signal; and
analogue delaying the first audio signal.

18. The method as claimed in claim 16, wherein signal processing comprises:
analogue to digital converting the first audio signal to generate a digital representation of the first audio signal;
digital signal processing the digital representation of the first audio signal and generate a digital representation of the second audio signal; and
digital to analogue converting the digital representation of the second audio signal to generate the second audio signal.

19. The method as claimed in claim 18, wherein digital signal processing comprises at least one of:
filtering the digital representation of the first audio signal;
mixing the digital representation of the first audio signal with a further signal; and
delaying the digital representation of the first audio signal.

20-22. (canceled)

23. The method as claimed in claim 13, further comprising capturing a third audio signal at a first earpiece first microphone transducer; and selecting the first audio signal to be coupled over selecting the third audio signal dependent on the first and third audio signal characteristics.

24-34. (canceled)
